(19) United States
(12) Patent Application Publication
(10) Pub. No.: US 2004/0182597 A1
(43) Pub. Date: Sep. 23, 2004

(54) Carbon-core transmission cable

(76) Inventors: Jack B. Smith, Lebanon, ME (US); Ryan H. Gauthier, Sanford, ME (US)

Correspondence Address: BOHAN, MATHERS & ASSOCIATES, LLC, PO BOX 17707, PORTLAND, ME, 04112-8707, US

(21) Appl. No.: 10/804,655

(22) Filed: Mar. 19, 2004

Related U.S. Application Data
(60) Provisional application No. 60/456,583, filed on Mar. 20, 2003.

(51) Int. Cl. H02G 3/00

(52) U.S. Cl. 174/126.1

(57) ABSTRACT

A high-voltage transmission cable having a carbon fiber core. The outer conductor is aluminum. The carbon core is enshrouded in a sheath that prevents the formation of a galvanic cell at the aluminum-carbon interface and provides a slip plane between the carbon core and outer conductor. The high-voltage transmission cable has insignificant sag, is operable at greater ampacity and greater temperature than conventional ACSR cable of comparable size, and is a cost-effective replacement for conventional ACSR cables. Use of the high-voltage transmission cable allows greater volume of power to be distributed over the existing power transmission grid.

### BACKGROUND INFORMATION

1. Field of the Invention

The field of the invention relates to electrical overhead transmission cable. More particularly, the invention relates to high-voltage transmission cable.

Description of the Prior Art

The conventional overhead transmission line conductor or cable currently in use in 95% of the transmission lines used in the United States and Europe is an Aluminum Conductor Steel Reinforced (ACSR) cable. With most ACSR cable, the aluminum outer conducting layer and the steel inner core share the structural load, with the load-bearing ratio of aluminum to steel varying nominally between 25/75% and 50/50%, depending on the cable configuration. There are numerous cable configurations which have been designed to offer a wide range of structural and electrical capabilities. Each configuration has a steady-state thermal rating, which is the maximum allowable temperature, and an ampacity rating that represents the maximum allowable continuous current carrying capacity of the cable for that steady-state thermal rating. Typically, most ACSR cable is rated for operation at a maximum steady-state temperature of 75 degrees C. For example, the Drake, a commonly used ACSR transmission cable, has an ampacity rating of 907 Amps for a steady-state thermal rating of 75 degrees C. At times of peak demand, the utilities are allowed to operate their transmission cables at emergency temperatures above 75 degrees C. for only short periods. Careful consideration is given to not allow a transmission cable to remain at elevated temperatures for extended duration. Not only will the cable experience additional line sag, which may present a danger of arcing to ground, but the structural properties of the aluminum and/or steel may also degrade. Table 1 below shows the ampacity ratings for several conventional transmission cables used in the field.

TABLE 1

| | Size | Strand | Diameter | Weight | Strength | Ampacity |
|---|---|---|---|---|---|---|
| Type | kcmil* | (Al/Steel) | in | lb/1000 ft | lb | amps |
| ACSR/Drake | 795 | 26/7 | 1.108 | 1093 | 31,500 | 907 (75° C.) |
| ACSR/Bluebird | 2156 | 84/19 | 1.762 | 2508 | 60,300 | 1623 (75° C.) |
| AAC/Lilac | 795 | 61/— | 1.028 | 746 | 14,300 | 879 (75° C.) |
| AAC/Sagebrush | 61250 | 91/— | 1.729 | 2128 | 37,500 | 1612 (75° C.) |

ACSR - Aluminum Conductor Steel Reinforced
AAC - All Aluminum Conductor
*Standard unit of aluminum cross section

Overhead transmission cables are strung on towers and stretch along transmission corridors that crisscross the countryside and form the power distribution grid. Today, utility providers face the dilemma of an ever increasing demand for power along with fierce opposition from the general population to any plan to expand the existing transmission grid, be it by widening the existing corridors or adding new corridors. One solution would be to increase the volume of electrical power transmitted along the existing transmission grid; in other words, to increase the loads carried by the transmission cables in the existing transmission grid. The problem with that solution is that, as current flow increases along a conductor, so do resistive losses, with the result that the conductor heats up to higher temperatures. As indicated above, the allowable operating temperature of a particular size of cable may not exceed the steady-state thermal rating, except for brief periods. The coefficients of thermal expansion (CTE) for steel and for aluminum are high. As a result, the length of a transmission cable of aluminum and steel increases proportionately and significantly as the metals heat up. Thus, a direct result of a temperature increase is greater line sag on the transmission cable. If the temperature increase is great enough, the line sag may be sufficient to present the danger of arcing to the ground. By way of example, based on an experimental value of the CTE of the steel in the ACSR Drake cable at 85% of the theoretical strength of the steel, the Drake cable has a line sag of 21.3 ft/1000 ft at 23 degrees C., 29.5 ft at 200 degree C., and 48.5 ft at 262 degrees C. Thus, the amount of power that can safely flow across a transmission conductor at any given voltage is limited by the amount of heat generated by the power.

Given that it is so difficult to geographically expand the power transmission grid and given the limits to pushing greater amounts of power over the existing ACSR cable, a third solution to the problem of greater demand for power is to replace the existing ACRS cable with cable that is operable at higher temperatures and has an invariant or insignificant line sag. The new cable would, however, also have to be cost-effective, that is, not be more costly than the cost of using conventional cable in an expanded transmission grid.

What is needed therefore, is a high-voltage transmission cable that is operable at temperatures higher than those admissible for conventional ACSR cable and yet has insignificant line sag. What is further needed, is such a cable that that is rated to operate at higher temperatures so as to provide increased ampacity. What is yet further needed, is such a cable that has an increased strength-to-weight ratio. Finally, what is needed is such a cable that provides a cost-effective solution to increased power flow over existing transmission grid.

### BRIEF SUMMARY OF THE INVENTION

For reasons stated above, it is an object of the present invention to provide a high voltage transmission cable that is operable at temperatures higher than those admissible for conventional ACSR cable and yet has insignificant line sag. It is a further object to provide such a cable that is rated to operate at higher temperatures so as to provide increased ampacity. It is a yet further object to provide such a cable that has an increased strength-to-weight ratio and that provides a cost-effective solution to increased power flow over existing transmission grid.

The objects are achieved by providing a carbon-core (C-C) transmission cable according to the invention comprising a carbon core and an aluminum conductor. A sheath or protective overwrap is provided around the carbon core. The sheath serves as a slip plane between the carbon core and the conductor and also prevents galvanic action between the carbon core and the aluminum conductor.

Carbon has an extremely small coefficient of thermal expansion (CTE). Pure carbon actually has a slightly negative CTE, that is, a pure carbon filament decreases slightly in length with a rise in temperature. Carbon filament also has a very high specific tensile strength, much greater than that of steel. These are desirable characteristics for a transmission cable material. A drawback to the use of carbon filaments is that carbon filament is relatively weak against diametric shear. Inventor has determined that embedding carbon filaments in a polymer matrix significantly increases the shear strength of the carbon filaments. As a result, a carbon-composite rod comprising carbon filaments embedded in a polymer matrix was developed. The carbon-composite rod has a very slight, positive CTE. Thus, the carbon-composite rod has a very small CTE, very high tensile strength, and, in addition to these desirable characteristics, has a strength-to-weight ratio that is potentially twice that of steel. These qualities of the carbon-composite rod according to the invention provide an ideal core material for a high-voltage transmission cable, because such a cable has so little sag at a significant rise in temperature. As a result, the C-C transmission cable according to the invention is referred to as a cable with “invariant sag” meaning that the C-C transmission cable, as it heats up, exhibits very little sag. Because the sag is so minimal, the use of the C-C transmission cable according to the invention enables steady-state operation at temperatures far above currently allowable temperatures.

The carbon core in the C-C transmission cable according to the invention encompasses various reinforcement configurations of carbon fiber. The C-C transmission cable operates at significantly higher temperatures than are currently admissible for conventional ACSR cable. Because of the higher operating temperatures, the polymer matrix used for embedding the carbon filaments is selected for its properties to withstand high temperatures. Suitable polymers for the polymer matrix include both thermoplastic and thermoset polymers. A particularly suitable high-temperature polymer matrix is the thermoset polymer polyetheretherketone, commercially known as PEEK™. It is understood that high-temperature thermoplastic materials, such as high-temperature phenolics, are also suitable for the polymer matrix material, and that the use of a high-temperature thermoset polymer for the carbon core matrix does not limit the scope of the invention.

Because of the dissimilar materials used for the core and the conductor, galvanic cells may form at the interface between the materials. A sheath or protective overwarp is provided around the carbon core, to prevent any contact between the two materials. Any number of materials may be used for the sheath. One type of material that is particularly suited is poly-paraphenylene terepththalmide, poly p-phenylene, or aramid fiber, commercially known as KEVLAR®. The aluminum conductor and the carbon-core also have different CTEs and, as a result, the aluminum conductor will move along the carbon core as it heats up. It may be desirable to use a material for the sheath that will provide a slip plane and reduce friction between the two materials. A suitable material that provides the desired slip plane is polytetrafluoroethylene (PTFE) or pluoropolymer, commercially known as TEFLON@. The sheath may be applied to the core in any number of ways, depending on the material used. PTFE may be applied in liquid form to the core, either with a sprayer, a brush, or a roller. Depending on the material used for the sheath, it may also be braided or extruded over, or adhesively applied to, the carbon core.

The typical aluminum conductor, which comprises circular-sectioned aluminum rods that are wrapped about the core of the cable with a slight twist, remains a suitable conductor for the C-C transmission cable according to the invention. The invention further encompasses other configurations of the aluminum conductor about the carbon core that will provide the desired current-carrying capacity and also provide the flexibility needed for winding the conductor about a spool. For example, the aluminum conductor may be a relatively slender conductor that is wrapped with a pronounced twist about the core, or a sectioned conductor, the section having a shape that allows the conductor to flex along the axial direction. The conductor may also be a coating that is applied in one or more layers around the core, such as an aluminum tape.

To make the C-C transmission cable, it is important that the carbon filaments be twisted as little as possible, both in the production of the core and in operation of the cable, because of carbon's weakness in shear. Some twist in the cable is necessary, to give it the flexibility needed to wind it on a spool. There are several possibilities of providing the necessary flexibility to the cable, without unduly stressing the carbon fibers. In the carbon core according to the invention, the carbon fibers are pultruded in the high-temperature polymer matrix and bundled to form circular sectioned carbon-fiber reinforced composite rods. Still another configuration provides trapezoidally sectioned pultruded carbon-fiber reinforced rods that are bundled about a center carbon fiber reinforced rod that is pentagonally or hexagonally shaped. The rods are bundled inside the sheath to form the carbon core, whereby the rods are bundled either as straight or slightly twisted rods.

### BRIEF DESCRIPTION OF THE DRAWINGS

The present invention is described with reference to the accompanying drawings. In the drawings, like reference numbers indicate identical or functionally similar elements.

FIG. 1 illustrates a first configuration of the preferred embodiment of the C-C transmission cable according to the invention, showing the carbon core, the protective sheath, and the aluminum conductor.

FIG. 2 illustrates a second configuration of the preferred embodiment of the C-C transmission cable according to the invention.

FIG. 3 illustrates a third configuration of the preferred embodiment of the C-C transmission cable according to the invention.

FIG. 4 illustrates a fourth configuration of the preferred embodiment of the C-C transmission cable according to the invention.

FIG. 5 illustrates a fifth configuration of the preferred embodiment of the C-C transmission cable according to the invention.

FIG. 6 illustrates a first alternative embodiment of the C-C transmission cable according to the invention, showing a braided rope carbon core encased in the protective sheath.

FIG. 7 illustrates a second alternative embodiment of the C-C transmission cable according to the invention, showing a carbon core that is bundle of dry carbon fibers encased in a sheath.

### DETAILED DESCRIPTION OF THE INVENTION

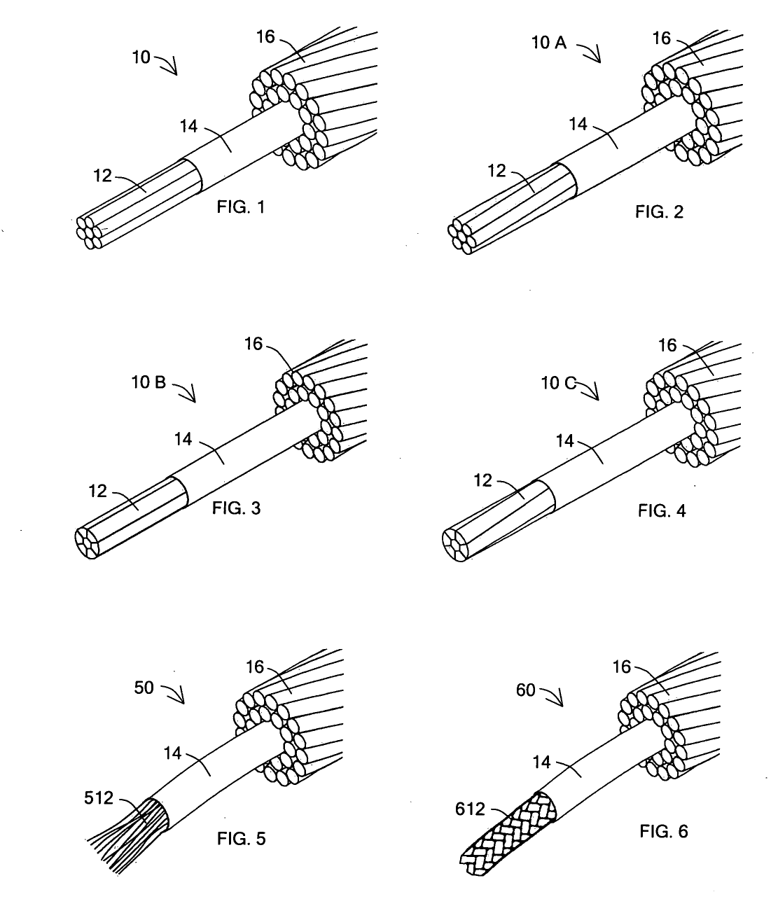

FIGS. 1 to 5 illustrate various configurations of the preferred embodiment of the present invention. FIG. 1 illustrates a first configuration of a C-C transmission cable 10 according to the invention comprising an outer conductor 16, a carbon-core 12, and a sheath 14. The outer conductor 16 in the embodiments shown is typically a conventional aluminum conductor of the type used for ACSR high-voltage transmission lines. The carbon core 12 shown in FIG. 1 is a straight pultruded, circular-sectioned carbon-fiber reinforced composite core. The carbon fibers are pultruded in a high-temperature polymer matrix.

FIG. 2 illustrates a second configuration of the preferred embodiment C-C transmission cable 10A comprising the outer conductor layer 16, the sheath 14, and a carbon core 12, wherein the rods of the carbon core 12 are slightly twisted. FIGS. 3 and 4 illustrate a third and fourth configuration, respectively, of the preferred embodiment C-C transmission cable 10A and 10A, 10B, 1° C. These third and fourth configurations comprise the outer conductor layer 16, the carbon core 12, and the sheath 14, wherein the rods of the carbon core 12 are variously sectioned rods. In the configurations shown, the outer rods are substantially trapezoidal and the inner central rod is hexagonal in shape. FIG. 5 illustrates a configuration in which the outer conductor layer 16 is wrapped with a pronounced twist about the carbon core 12 and the sheath 14.

The polymer matrix of the preferred embodiment of the C-C transmission cable may be a high-temperature thermoset polymer, such as polyetheretherketone, commercially available under the name PEEK™, or a high-temperature thermoplastic material, such as a high-temperature phenol-formaldehyde phenolic resin. In the embodiments shown, the sheath 14 is a woven or wrapped sheath, the purpose of which is to prevent the formation of a galvanic cell at the area of contact between the carbon and aluminum. A suitable material for the sheath is poly-paraphenylene terepththalmide, commercially available under the name KEVLAR®. The sheath 14 also serves as a slip plane to reduce friction between the outer conductor layer 16 and the carbon core 12. As such, other materials may be very suitable for use as the sheath, provided they isolate the carbon core 12 from the aluminum conductor and can withstand the high operating temperatures of the C-C transmission cable 10. PTFE, for example, is a very suitable sheath material. Other suitable materials include ethylene tetrafluoroethylene copolymer (ETFE), which is available from DuPont, and a silicone conformal coating available from Humiseal. Depending on whether the sheath material is liquid, woven, extrudable, etc., when it is applied to the carbon core 12, it may be wrapped around the core, braided and pulled over the core, extruded over the core, or applied with a brush, a sprayer, or a roller.

There are a number of polymeric materials that are suitable for use as the polymer matrix in the carbon core 12, and/or for the sheath 14. Examples of such materials, available from Minnesota Rubber & QMR Plastics, include the following high-performance polymers: polyimide; polyamideimide; polyetheretherketone; thermoplastic polyimide; fluoropolymers; polyphenylsulfone; polyvinylidene fluoride; polyetherimide; liquid crystal polymers; polyethersulfone; polyphenylene sulfide; polysulfone; polyphthalamide; polyarylate; polyamide-4,6; polyphthalate carbonate; and polyethylene terephthalate. Depending on the particular intended application of the atcc according to the invention, the following mid-range performance polymers may be suitable for use as the polymer matrix in the carbon core 12 and/or for the sheath 14: poly carbonate; polybutylene terphthalate; polyamide-6/6,6; polyphenylene oxide; polyoxymethylene; ultrahigh molecular weight polyehtylene; styrene maleic anhydride; acrylonitrilebutadienestyrene; polymethyl methacrylate; and polypropylene.

FIG. 6 illustrates a first alternative embodiment of a C-C transmission cable 50 according to the invention. The C-C transmission cable 50 comprises the outer conductor layer 16 and the sheath 14, with a braided carbon core 512. The fiber used in the braided carbon core 512 is from a high modulus (HM), commercial grade PAN (polyacrylonitride) based carbon fiber from Zoltek, Panex 33®, with a 48K-tow filament.

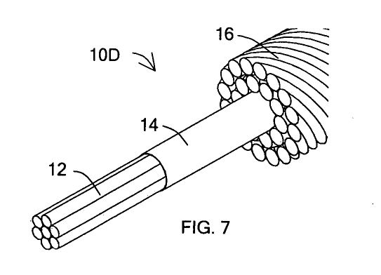

FIG. 7 illustrates a second alternative embodiment of a C-C transmission cable 60 according to the invention. The C-C transmission cable 60 comprises the outer conductor layer 16 and a carbon core 612 made of a dry carbon fiber rope. The fiber used to fabricate the carbon core 612 is a HM commercial grade of Amoco T300 grade 12K tow polyacrylonitride based carbon fiber. The design concept of the carbon core 612 employs a unidirectional fiber reinforcement architecture. The carbon core 612 is pulled up into a braid by the sheath material to produce a double-thickness braid with a parallel core of HM carbon fiber. An advantage of the carbon core 612 is that it further increases the strength of the dry carbon fibers by avoiding the braiding process, i.e., passing the fiber tows over and under one another, which would increase the shear and subsequently reduce the axial tensile load bearing capability of the carbon core 612.

Rated Breaking Strength (RBS) of the carbon core: Tow and strand tests were performed to determine fundamental strength characteristics of the carbon cores. The tests were performed both dry (without a polymer matrix) and with a polymer matrix (epoxy) to determine the effect of a polymer matrix material on shear load transfer between fibers. Both the braided carbon core 512 and the unidirectional carbon core 612 were tested to determine their respective RBS. The results of the tow test determined an average dry strength of 133 lb and an averaged epoxied strength of 324 lb. The results for a dry seven (7) tow strand was 934 lb. The complete results are shown in Table 1. The results of these tests show the braided carbon core 512 was about 12 the stiffness of the unidirectional carbon core 612. This difference in stiffness is due to the braid architecture. The average RBS of the braided carbon core 512 was 7,450 lbf and the unidirectional carbon core 612 was 7,440 lbf. The results of the test are shown below in Table 1.

TABLE 1

| | | RBS | RBS/Theory RBS |
|---|---|---|---|
| Test | Material | lbf | ratio |
| Braided Rope #1 | PANEX ® 33 | 7,400 | 0.194 |
| Braided Rope #2 | PANEX ® 33 | 7,510 | 0.197 |
| Unidirectional Rope #1 | Thornel ® T-300 | 7,110 | 0.268 |
| Unidirectional Rope #2 | Thornel ® T-300 | 7,840 | 0.296 |
| Unidirectional Rope #3 | Thornel ® T-300 | 7,360 | 0.278 |
| Average Tow (Dry) | Thornel ® T-300 | 106 | 0.329 |
| Average Tow (Epoxy) | Thornel ® T-300 | 324 | 0.856 |
| Average Strand (Dry) | Thornel ® T-300 | 934 | 0.353 |

The results of the RBS tests show a reduced strength without the use of a polymer matrix material in the tow tests. Tow tests with the use of a polymer matrix material tested to 85% of the theoretical fiber strength, whereas the dry tow and strands tested to 33% and 35% of the theoretical fiber strength, respectively. It should be noted that for the two trial samples listed above, the actual volume fraction of carbon fiber was 51.5% for the braided carbon core 512, based on a core diameter of 0.4135 in, and 69.3% for the unidirectional carbon core 612, based on a diameter of 0.3035 in. The actual Drake ACSR cable has a steel core diameter of 0.408 in and a steel volume fraction of 24.3%. In order to make direct comparisons in the following sections, the diameter of the carbon core and the volume fraction are assumed to be equal with that of the steel core of the Drake.

In addition to the thermal behavior, the C-C transmission cables 10, 50, and 60 according to the invention with the carbon cores 12, 512, and 612 exhibit a lower overall conductor weight per unit length. This is because the carbon core is 4.4 times lighter that a steel core of corresponding diameter. This translates to a 26% weight savings relative to the Drake ACSR transmission cable and a strength-to-weight ratio that is potentially 2 times greater than that of steel.

It is understood that the embodiments described herein are merely illustrative of the present invention. Variations in the construction of the C-C transmission cable may be contemplated by one skilled in the art without limiting the intended scope of the invention herein disclosed and as defined by the following claims.

What is claimed is:

1. A high-voltage transmission cable comprising:
an aluminum conductor, an electrically insulative sheath, and a carbon core,
wherein said aluminum conductor surrounds said sheath and said sheath surrounds said carbon core.

2. The transmission cable of claim 1, wherein said sheath is made of a material capable of withstanding an operating temperature greater than 150 degrees C.

3. The transmission cable of claim 2, wherein said sheath is made of PTFE.

4. The transmission cable of claim 2, wherein said sheath is made of a material from the group consisting of poly-paraphenylene terepththalmide, poly p-phenylene, aramid fiber, and combinations thereof.

5. The transmission cable of claim 2, wherein said sheath has a low coefficient of friction and provides a slip plane to reduce wear between said aluminum conductor and said carbon core.

6. The transmission cable of claim 1, wherein said carbon core comprises a carbon-fiber reinforced composite rod.

7. The transmission cable of claim 6, wherein said carbon-fiber reinforced composite rod comprises carbon fiber pultruded in a high-temperature polymeric material.

8. The transmission cable of claim 6, wherein said high-temperature polymeric material includes materials from the group consisting of thermoset polymers, thermoplastic polymers, and combinations thereof.

9. The transmission cable of claim 6, wherein said carbon core includes a plurality of said carbon-fiber reinforced composite rods.

10. The transmission cable of claim 9, wherein one or more of said rods are substantially trapezoidal in shape.

11. The transmission cable of claim 6, wherein said carbon core is a bundle of said plurality of said carbon-fiber reinforced composite rods, and wherein said rods are twisted slightly axially.

12. The transmission cable of claim 6, wherein said plurality of said carbon core is a bundle of said plurality of carbon-fiber reinforced composite rods, and wherein said rods are axially aligned.

13. The transmission cable of claim 1, wherein said carbon core comprises a braid of dry carbon fibers.

14. The transmission cable of claim 1, wherein said carbon core comprises a rope of unidirectionally aligned dry carbon fibers.

15. The transmission cable of claim 1, wherein said aluminum conductor includes a plurality of aluminum rods.

16. The transmission cable of claim 15, wherein said plurality of aluminum rods are twisted slightly relative to an axial direction of said cable.

17. The transmission cable of claim 15, wherein said plurality of aluminum rods are wrapped axially about said core and said sheath.

18. The transmission cable of claim 1, wherein said aluminum conductor is a sectioned aluminum coating over said sheath and said carbon core.

19. The transmission cable of claim 18, wherein said sectioned aluminum coating is applied over said sheath and said carbon core.
